(19) United States
(12) Patent Application Publication
(10) Pub. No.: US 2025/0273981 A1
(43) Pub. Date: Aug. 28, 2025

(54) DARK START POWER SUPPLY CALIBRATION AND OPTIMIZER

(71) Applicant: FORD GLOBAL TECHNOLOGIES, LLC, Dearborn, MI (US)

(72) Inventors: Richard Mo, Canton, MI (US); Timothy Harris, Grosse Ile, MI (US); Benjamin Kulhawik, Chelsea, MI (US)

(21) Appl. No.: 18/588,484

(22) Filed: Feb. 27, 2024

(51) Int. Cl. H02J 7/34; B60L 53/14; B60L 53/30

(52) U.S. Cl. CPC H02J 7/342; B60L 53/14; B60L 53/305; H02J 7/345

(57) ABSTRACT

Bidirectional energy transfer systems are provided for transferring energy between an electrified vehicle and other structures. The bidirectional energy transfer system may utilize dark start reserve power from a dark start energy storage resource for maintaining communications between electric vehicle supply equipment (EVSE) and a combiner box during grid power outage conditions. An output voltage of the dark start energy storage resource may be boosted within a variable voltage regulated boost circuit of the combiner box in order to supply a calibrated output voltage to the EVSE. The calibrated output voltage compensates for voltage drops that can occur across a length of a cable that extends between the EVSE and the combiner box.

### TECHNICAL FIELD

This disclosure relates generally to bidirectional energy transfer systems capable of transferring energy between an electrified vehicle and other structures.

### BACKGROUND

Plug-in type electric vehicles include one or more charging interfaces for charging a traction battery pack. Plug-in vehicles are typically charged while parked at a charging station or some other utility power source. Plug-in vehicles can also be used to support household loads during electrical power outages.

### SUMMARY

A bidirectional energy transfer system according to an exemplary aspect of the present disclosure includes, among other things, an electric vehicle supply equipment (EVSE), and a combiner box including a dark start energy storage resource and a variable voltage regulated boost circuit configured to boost an output voltage of the dark start energy storage resource for powering a circuitry of the EVSE during a grid power outage condition.

In a further non-limiting embodiment of the foregoing bidirectional energy transfer system, the dark start energy storage resource is a battery, a capacitor, or a supercapacitor.

In a further non-limiting embodiment of either of the foregoing bidirectional energy transfer systems, the variable voltage regulated boost circuit is configured to boost the output voltage to compensate for a voltage drop that can occur across a length of a cable that extends from the EVSE to the combiner box.

In a further non-limiting embodiment of any of the foregoing bidirectional energy transfer systems, the cable is a Power over Ethernet (POE) cable.

In a further non-limiting embodiment of any of the foregoing bidirectional energy transfer systems, a control system is programmed to control the variable voltage regulated boost circuit for boosting the output voltage during the grid power outage condition.

In a further non-limiting embodiment of any of the foregoing bidirectional energy transfer systems, the control system includes a first control module of the combiner box and a second control module of the EVSE.

In a further non-limiting embodiment of any of the foregoing bidirectional energy transfer systems, the second control module is programmed to determine a voltage drop based on a comparison between a measured output voltage received from the variable voltage regulated boost circuit and a calibrated output voltage setting received from the first control module.

In a further non-limiting embodiment of any of the foregoing bidirectional energy transfer systems, the first control module is programmed to determine a calibrated output voltage for powering the circuitry based on the voltage drop.

In a further non-limiting embodiment of any of the foregoing bidirectional energy transfer systems, the first control module is programmed to command the variable voltage regulated boost circuit to adjust the output voltage to the calibrated output voltage for powering the circuitry.

In a further non-limiting embodiment of any of the foregoing bidirectional energy transfer systems, the EVSE includes a dark start measurement circuit configured for measuring the output voltage.

In a further non-limiting embodiment of any of the foregoing bidirectional energy transfer systems, the EVSE further includes a filter and a switched-mode power supply (SMPS).

A method according to another exemplary aspect of the present disclosure includes, among other things, boosting an output voltage of a dark start energy storage resource of a combiner box during a grid power outage condition, and powering communications between an electric vehicle supply equipment (EVSE) and an electrified vehicle using the boosted output voltage.

In a further non-limiting embodiment of the foregoing method, the combiner box includes a variable voltage regulated boost circuit that is configured to boost the output voltage.

In a further non-limiting embodiment of either of the foregoing methods, boosting the output voltage includes sending a calibrated output voltage setting and a first output voltage from the combiner box to the EVSE.

In a further non-limiting embodiment of any of the foregoing methods, boosting the output voltage further includes measuring the first output voltage within a dark start measurement circuit of the EVSE to determine a measured output voltage received by the EVSE.

In a further non-limiting embodiment of any of the foregoing methods, boosting the output voltage includes comparing the measured output voltage to the calibrated output voltage setting, and determining a voltage drop.

In a further non-limiting embodiment of any of the foregoing methods, boosting the output voltage includes sending the voltage drop to the combiner box.

In a further non-limiting embodiment of any of the foregoing methods, boosting the output voltage includes adjusting the first output voltage to a second output voltage that is derived from the voltage drop.

In a further non-limiting embodiment of any of the foregoing methods, the second output voltage is a sum of the voltage drop plus a minimum required voltage output that is necessary for maintaining a proper control pilot operation between the EVSE and the electrified vehicle.

In a further non-limiting embodiment of any of the foregoing methods, in response to establishing the communications between the EVSE and the electrified vehicle, the method includes transferring power from the electrified vehicle to a structure that is separate from the electrified vehicle during the grid power outage condition.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a first configuration of a bidirectional energy transfer system.

FIG. 2 schematically illustrates a second configuration of the bidirectional energy transfer system of FIG. 1.

FIG. 3 schematically illustrates additional aspects of the bidirectional energy transfer system of FIGS. 1 and 2.

FIG. 4 is a flow chart of an exemplary method for controlling a bidirectional energy transfer system during a grid power outage condition.

### DETAILED DESCRIPTION

This disclosure relates to bidirectional energy transfer systems capable of transferring energy between an electrified vehicle and other structures. The bidirectional energy transfer system may utilize dark start reserve power from a dark start energy storage resource for maintaining communications between electric vehicle supply equipment (EVSE) and a combiner box during grid power outage conditions. An output voltage of the dark start energy storage resource may be boosted within a variable voltage regulated boost circuit of the combiner box in order to supply a calibrated output voltage to the EVSE. The calibrated output voltage compensates for voltage drops that can occur across a length of a cable that extends between the EVSE and the combiner box. These and other features of this disclosure are discussed in greater detail in the following paragraphs of this detailed description.

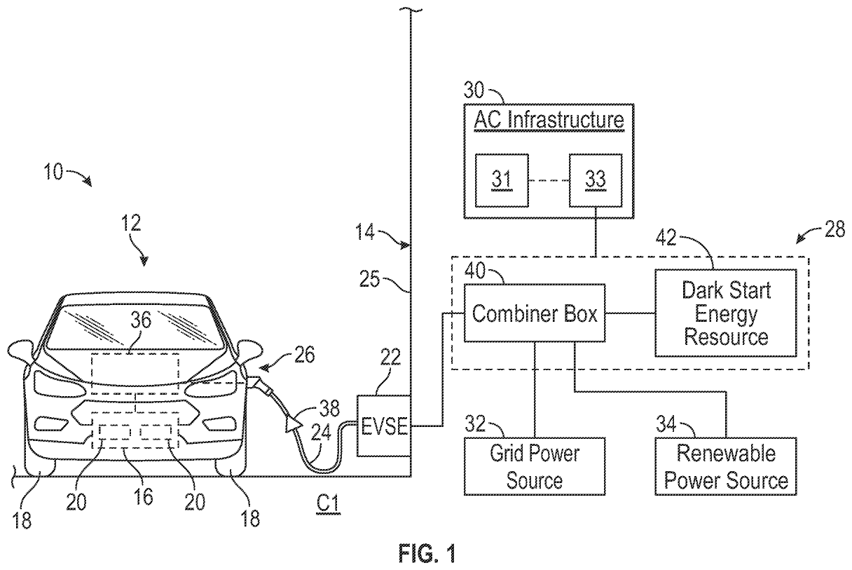

FIGS. 1, 2, and 3 schematically illustrate an exemplary bidirectional energy transfer system 10 (hereinafter “the system 10”) for bidirectionally transferring energy between a vehicle 12 and a structure 14. The system 10 enables the bidirectional transfer of energy from the vehicle 12 to the structure 14 or vice versa. The structure 14 may be a residential building, a commercial building, a parking garage, a charging station, or any other type of structure that is capable of receiving or transferring energy. In an embodiment, the structure 14 is a residential household that functions as a “home location” of the vehicle 12.

Although a specific component relationship is illustrated in the figures of this disclosure, the illustrations are not intended to limit this disclosure. The placement and orientation of the various components of the depicted system are shown schematically and could vary within the scope of this disclosure. In addition, the various figures accompanying this disclosure are not necessarily drawn to scale, and some features may be exaggerated or minimized to emphasize certain details of a particular component, assembly, or system.

In an embodiment, the vehicle 12 is a plug-in type electric vehicle (e.g., a plug-in hybrid electric vehicle (PHEV) or a battery electric vehicle (BEV)). The vehicle 12 includes a traction battery pack 16 that is part of an electrified powertrain capable of applying a torque from an electric machine (e.g., an electric motor) for driving wheels 18 of the vehicle 12. The electrified powertrain of the vehicle 12 may electrically propel the set of wheels 18 either with or without the assistance of an internal combustion engine.

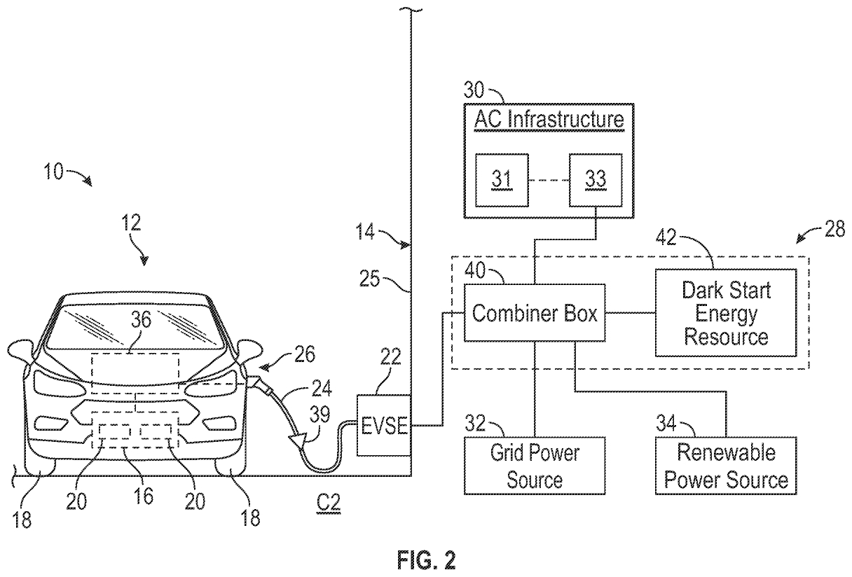

The vehicle 12 of FIGS. 1-2 is schematically illustrated as a car. However, other vehicle configurations are also contemplated. The teachings of this disclosure may be applicable for any type of vehicle as the vehicle 12. For example, the vehicle 12 could be configured as a car, a pickup truck, a van, a sport utility vehicle (SUV), etc.

Although shown schematically, the traction battery pack 16 may be configured as a high voltage traction battery pack that includes a plurality of battery arrays 20 (e.g., battery assemblies or groupings of battery cells) capable of outputting electrical power to one or more electric machines of the vehicle 12. Other types of energy storage devices and/or output devices may also be used to electrically power the vehicle 12.

The vehicle 12 may interface with the structure 14 through electric vehicle supply equipment (EVSE) 22 in order to perform the bidirectional energy transfers of the system 10. In an embodiment, the EVSE 22 is a wall box that may be mounted to a wall 25 of the structure 14. A charge cable 24 may operably connect the EVSE 22 to a charge port assembly 26 of the vehicle 12 for transferring energy between the vehicle 12 and the structure 14. The charge cable 24 may be configured to provide any level of charging (e.g., 120 VAC, 240 VAC, Direct Current (DC) charging, etc.).

The EVSE 22 may be operably connected to an AC infrastructure 30 of the structure 14 through a home energy management system 28. The home energy management system 28 may include a combiner box 40, which is a type of bidirectional energy transfer module. Various electrical loads 31, such as household appliance loads, for example, may be associated with the AC infrastructure 30. The electrical loads 31 may sometimes be referred to as transient loads of the AC infrastructure 30 and could include loads associated with common kitchen appliances, washers, dryers, water heaters, air conditioning units, furnaces, home alarms systems, sump pump systems, routers, home lighting systems, etc. The AC infrastructure 30 may further include a main service panel 33 that is operably positioned between the combiner box 40 and the electrical loads 31.

Power from a grid power source 32 (e.g., AC power), a renewable power source 34 (e.g., solar power, wind power, etc.), the vehicle 12, or some combination of these may be selectively transferred to the AC infrastructure 30 for powering the electrical loads 31. The combiner box 40 can control power transfer to the AC infrastructure 30. The combiner box 40 can in some implementations further control power transfer to the grid power source 32. For example, power from the vehicle 12 could periodically be transferred through the combiner box 40 back to the grid power source 32.

The combiner box 40 may function as a junction between the AC infrastructure 30 and each of the grid power source 32, the vehicle 12, and the renewable power source 34. The combiner box 40 can electrically isolate the AC infrastructure 30 from the grid power source 32 during a grid power outage condition and can control the electrical loads 31 ON and OFF. In an embodiment, the combiner box 40 can activate a transfer switch to decouple the grid power source 32 from the electrical loads 31, and then transfer power from the renewable power source 34, the vehicle 12, or both to the electrical loads 31.

Power received from or transferred to the vehicle 12 may be transferred through the combiner box 40. The combiner box 40 is configured to aid bidirectional transfers of electrical energy between the vehicle 12 and the structure 14. The home energy management system 28 may include various equipment necessary for achieving the transfers of energy to/from the vehicle 12.

The vehicle 12 may further include a vehicle power transfer system 36 configured for further enabling the bidirectional transfer of power between the vehicle 12 and the structure 14. The vehicle power transfer system 36 may be operably connected between the charge port assembly 26 and the traction battery pack 16 of the vehicle 12. The vehicle power transfer system 36 may include various equipment for enabling the vehicle 12 to act as a backup power source for transferring power to the structure 14, such as a charger, a converter, an inverter, HV relays or contactors, a motor controller (which may be referred to as an inverter system controller or ISC), etc. The vehicle power transfer system 36 may further be configured to enable the vehicle 12 to receive power from the structure 14 and for transferring energy between the traction battery pack 16 and one or more electric motors of the vehicle 12.

One non-limiting example of a suitable vehicle power transfer system that may be employed for use within the vehicle 12 for achieving bidirectional power transfers is disclosed within US Patent Publication No. 2020/0324665, assigned to Ford Global Technologies, LLC, the disclosure of which is incorporated herein by reference. However, other power transfer systems could also be utilized for achieving bidirectional power transfers within the scope of this disclosure.

FIG. 1 schematically illustrates a first configuration C1 of the system 10. During the first configuration C1, power may be transferred from the structure 14 to the vehicle 12, such as for charging the traction battery pack 16 of the vehicle 12. The direction of energy transfer during the first configuration C1 is schematically depicted by arrow 38.

FIG. 2 schematically illustrates a second configuration C2 of the system 10. During the second configuration C2, power may be transferred from the traction battery pack 16 of the vehicle 12 to the structure 14. The direction of energy transfer during the second configuration C2 is schematically illustrated by arrow 39. In this way, the vehicle 12 may be employed as a backup energy management system for powering the electrical loads 31 of the structure 14, such as when power from the grid power source 32 is temporarily unavailable as a result of electrical blackouts, for example.

The EVSE 22 may be configured to communicate with both the vehicle 12 and the combiner box 40 to facilitate transfers of power from the vehicle 12 to the structure 14 for powering the electrical loads 31 of the AC infrastructure 30. The EVSE 22 is operably coupled to the vehicle 12 when transferring power from the vehicle 12. The EVSE 22 is operably coupled to the structure 14 through the combiner box 40.

As can be appreciated, the EVSE 22 and the combiner box 40 are ordinarily powered by the grid power source 32. However, during a grid power outage condition where energy from the grid power source 32 is temporarily unavailable, the EVSE 22 and the combiner box 40 still need to be powered to be able to detect the vehicle 12 and to communicate with one another for transferring power from the vehicle 12 to the structure 14. This is sometimes referred to as a “dark start.”

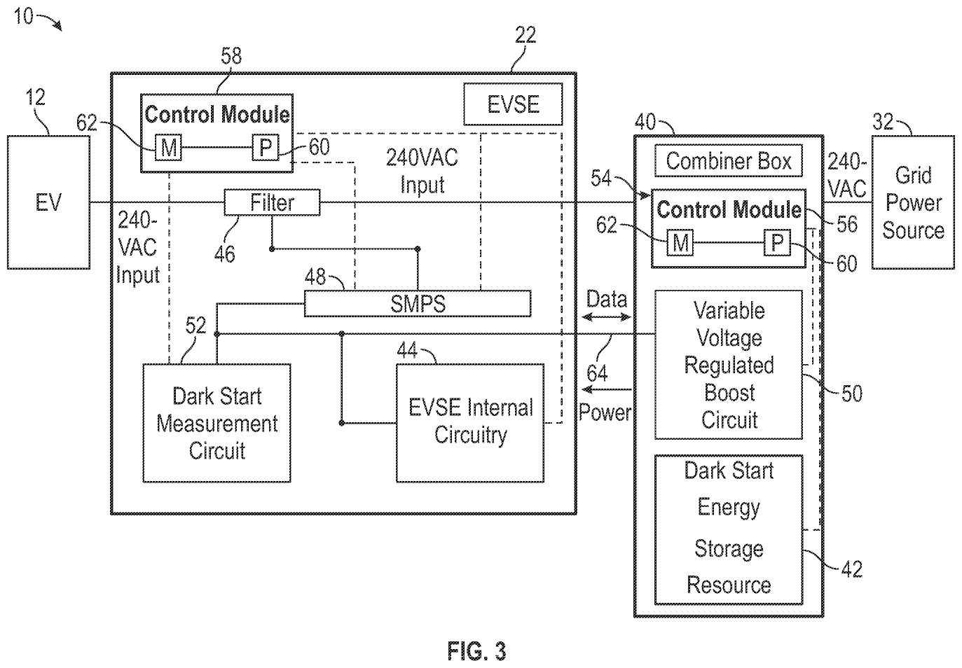

The home energy management system 28 may additionally include a dark start energy storage resource 42 that is operably connected to the combiner box 40. Although shown separately from the combiner box 40 in FIGS. 1-2, the combiner box 40 and the dark start energy storage resource 42 could be integrated together as part of a common module (see, e.g., FIG. 3).

The dark start energy storage resource 42 may be capable of supplying a limited amount of backup power to certain components of the system 10, such as the EVSE 22, for example, when power is unavailable from either the grid power source 32 or any other energy resource (e.g., the renewable power source 34). The dark start energy storage resource 42 may include a battery (e.g., a 13V battery), a capacitor, a supercapacitor or any other suitable energy storage device.

Referring now primarily to FIG. 3, the EVSE 22 may include internal circuitry 44, a filter 46, and a switched-mode power supply (SMPS) 48. The circuitry 44 may include the components necessary for the EVSE 22 to function to transfer energy between the vehicle 12 and the structure 14. The SMPS 48 may be a dual-mode SMPS that can receive input power from either the vehicle 12 or from the grid power source 32 through the combiner box 40. During normal operating conditions of the grid power source 32, power, such as 240 VAC power, for example, may be transferred to the filter 46 and then to the SMPS 48 from the grid power source 32. The SMPS 48 may convert the 240 VAC input from the grid power source 32 into a 12 VDC output that can be used to power the circuitry 44 of EVSE 22. The EVSE 22 and the combiner box 40 are therefore sufficiently powered to enable communications therebetween and with the vehicle 12 for preparing for and initiating the transfer of energy between the vehicle 12 and the structure 14.

As further discussed below, the EVSE 22 and the combiner box 40 may each include features that enable the EVSE 22 and the combiner box 40 to maintain communications with one another and with the vehicle 12 even when the grid power source 32 is unable to supply power to the system 10. These features, notably, do not require the EVSE 22 to include a battery that is sized to power every function of the EVSE 22. Accordingly, in this embodiment, the EVSE 22 is considered batteryless, which can reduce the overall packaging requirements of the EVSE 22.

The combiner box 40 may include a variable voltage regulated boost circuit 50 that is operably connected to the dark start energy storage resource 42. The variable voltage regulated boost circuit 50 may be configured to selectively boost an output voltage received from the dark start energy storage resource 42. Boosted power can then be transferred to the EVSE 22 for powering the circuitry 44 over a cable 64 that extends from the EVSE 22 to the combiner box 40. The output voltage from the dark start energy storage resource 42 may need to be boosted before being transferred to the EVSE 22 in order to account for a voltage drop that can occur due to cable resistance across a length of the cable 64 when the distance between the EVSE 22 and the combiner box 40 is relatively large (e.g., greater than 100 feet).

In an embodiment, the cable 64 is a Power over Ethernet (POE) cable. Accordingly, both power and data can be sent to the EVSE 22 over the cable 64.

The EVSE 22 may include a dark start measurement circuit 52. The dark start measurement circuit 52 may be configured to measure the boosted output voltage received from the variable voltage regulated boost circuit 50 when the dark start energy storage resource 42 is supplying backup power during a grid power outage condition. As further explained below, the output voltage measured by the dark start measurement circuit 52 can be used to determine a voltage drop over the length of the cable, which can then be used to adjust the calibrated output voltage provided by the variable voltage regulated boost circuit 50.

A control system 54 may control various functions associated with the system 10, and in particular may be programmed to control the EVSE 22 and the combiner box 40 to maintain communications and facilitate power export from the vehicle 12 to the structure 14 during grid power outage conditions. The control system may include at least a first control module 56 and a second control module 58. The first control module 56 may be a component of the combiner box 40, and the second control module 58 may be a component of the EVSE 22. Although two control modules are specifically shown, the system 10 could include a greater number of controllers that are operably linked and configured to function together for facilitating various control strategies associated with the system 10.

The first control module 56 and the second control module 58 may each include a processor 60 and non-transitory memory 62 for executing various control strategies and modes associated with the system 10. The processor 60 can be a custom made or commercially available processor, a central processing unit (CPU), or generally any device for executing software instructions. The memory 62 can include a combination of volatile memory elements and nonvolatile memory elements. Volatile memory elements require power to store data, whereas nonvolatile memory elements can store data without consuming power. The processor 60 may be operably coupled to the memory 62 and may be configured to execute one or more programs stored in the memory 62 based on the various inputs received from other devices, such as the dark start energy storage resource 42, the variable voltage regulated boost circuit 50, the dark start measurement circuit 52, etc.

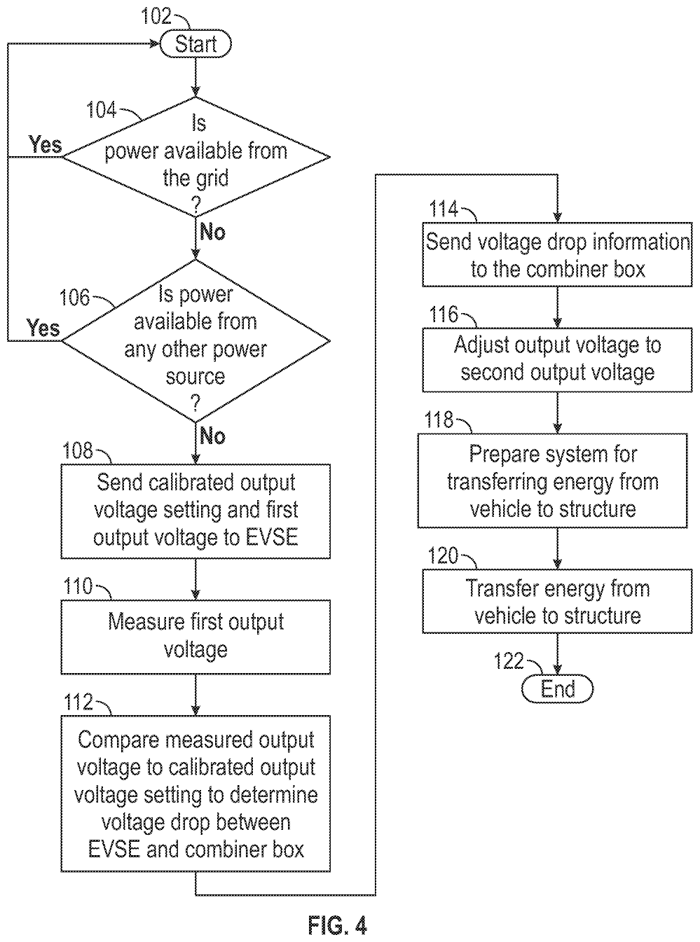

FIG. 4, with continued reference to FIGS. 1-3, schematically illustrates in flow chart form an exemplary method 100 for controlling the system 10 during a grid power outage condition. In particular, the system 10 may be controlled for efficiently using dark start reserve power from the dark start energy storage resource 42 to maintain communications between the EVSE 22 and the combiner box 40 during the grid power outage condition. The system 10 may be configured to employ one or more algorithms adapted to execute at least a portion of the steps of the exemplary method 100. For example, the method 100 may be stored as executable instructions in the memory(ies) of the control system 54, and the executable instructions may be embodied within any computer readable medium that can be executed by the processor(s) of the control system 54.

The exemplary method 100 may begin at block 102. At block 104, the method 100 may confirm whether or not power is available from the grid power source 32. If NO, thus indicating a grid power outage condition, the method 100 may proceed to block 106 by determining whether or not power is available from the renewable power source 34 or any other source. If block 106 returns a NO flag, the method 100 may proceed to block 108.

At block 108, the combiner box 40 may send both a calibrated output voltage setting (data) and a first output voltage (power) from the dark start energy storage resource 42 to the EVSE 22. The calibrated output voltage setting may be a preset value that is large enough to account for a worst case voltage drop over the cable 64 (e.g., 20V).

The dark start measurement circuit 52 of the EVSE 22 may measure the first output voltage at block 110 to determine a measured output voltage received by the EVSE 22. The measured output voltage may be compared to the calibrated output voltage setting (such as via the second control module 58, for example) to determine a voltage drop (data) between the EVSE 22 and the combiner box 40 at block 112. In an embodiment, the voltage drop is the difference between the calibrated output voltage setting and the first output voltage. At block 114, the voltage drop information may be sent to the combiner box 40 over the cable 64.

Next, at block 116, the variable voltage regulated boost circuit 50 (such as via commands from the first control module 56, for example) may adjust the output voltage from the dark start energy storage resource 42 to a second output voltage based on the voltage drop. In an embodiment, the second output voltage is calculated by adding the voltage drop value to a minimum required voltage output that is necessary for maintaining proper control pilot operation between the EVSE 22 and the vehicle 12. In an embodiment, the minimum required voltage output is 12V.

Since communications have been maintained between the EVSE 22 and the combiner box 40 using dark start energy, the method 100 may next proceed to block 118 and prepare the system 10 for transferring energy from the vehicle 12 to the structure 14. The vehicle 12 can then transfer energy to return power to the structure 14 at block 120. The method 100 may end at block 122.

The bidirectional energy transfer systems described herein include a dark start energy storage resource that can power system loads during grid power outage conditions. An output voltage of the dark start energy storage resource can be selectively boosted by a variable voltage regulated boost circuit to provide a calibrated output voltage to the EVSE that compensates for voltage drops. The proposed systems therefore eliminate the need for providing a dedicated power source within the EVSE and can further reduce the size of the dark start energy storage resource that is necessary to maintain operability of the system. Further, because the output of the boost circuit is a regulated voltage supply, the EVSE also does not require a secondary switching mode power supply, thereby further reducing components and complexity within the EVSE.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A bidirectional energy transfer system, comprising:
an electric vehicle supply equipment (EVSE); and
a combiner box including a dark start energy storage resource and a variable voltage regulated boost circuit configured to boost an output voltage of the dark start energy storage resource for powering a circuitry of the EVSE during a grid power outage condition.

2. The bidirectional energy transfer system as recited in claim 1, wherein the dark start energy storage resource is a battery, a capacitor, or a supercapacitor.

3. The bidirectional energy transfer system as recited in claim 1, wherein the variable voltage regulated boost circuit is configured to boost the output voltage to compensate for a voltage drop that can occur across a length of a cable that extends from the EVSE to the combiner box.

4. The bidirectional energy transfer system as recited in claim 3, wherein the cable is a Power over Ethernet (POE) cable.

5. The bidirectional energy transfer system as recited in claim 1, comprising a control system programmed to control the variable voltage regulated boost circuit for boosting the output voltage during the grid power outage condition.

6. The bidirectional energy transfer system as recited in claim 5, wherein the control system includes a first control module of the combiner box and a second control module of the EVSE.

7. The bidirectional energy transfer system as recited in claim 6, wherein the second control module is programmed to determine a voltage drop based on a comparison between a measured output voltage received from the variable voltage regulated boost circuit and a calibrated output voltage setting received from the first control module.

8. The bidirectional energy transfer system as recited in claim 7, wherein the first control module is programmed to determine a calibrated output voltage for powering the circuitry based on the voltage drop.

9. The bidirectional energy transfer system as recited in claim 8, wherein the first control module is programmed to command the variable voltage regulated boost circuit to adjust the output voltage to the calibrated output voltage for powering the circuitry.

10. The bidirectional energy transfer system as recited in claim 1, wherein the EVSE includes a dark start measurement circuit configured for measuring the output voltage.

11. The bidirectional energy transfer system as recited in claim 10, wherein the EVSE further includes a filter and a switched-mode power supply (SMPS).

12. A method, comprising:
boosting an output voltage of a dark start energy storage resource of a combiner box during a grid power outage condition; and
powering communications between an electric vehicle supply equipment (EVSE) and an electrified vehicle using the boosted output voltage.

13. The method as recited in claim 12, wherein the combiner box includes a variable voltage regulated boost circuit that is configured to boost the output voltage.

14. The method as recited in claim 12, wherein boosting the output voltage includes:
sending a calibrated output voltage setting and a first output voltage from the combiner box to the EVSE.

15. The method as recited in claim 14, wherein boosting the output voltage further includes:
measuring the first output voltage within a dark start measurement circuit of the EVSE to determine a measured output voltage received by the EVSE.

16. The method as recited in claim 15, wherein boosting the output voltage includes:
comparing the measured output voltage to the calibrated output voltage setting; and
determining a voltage drop.

17. The method as recited in claim 16, wherein boosting the output voltage includes:
sending the voltage drop to the combiner box.

18. The method as recited in claim 17, wherein boosting the output voltage includes:
adjusting the first output voltage to a second output voltage that is derived from the voltage drop.

19. The method as recited in claim 18, wherein the second output voltage is a sum of the voltage drop plus a minimum required voltage output that is necessary for maintaining a proper control pilot operation between the EVSE and the electrified vehicle.

20. The method as recited in claim 12, comprising, in response to establishing the communications between the EVSE and the electrified vehicle:
transferring power from the electrified vehicle to a structure that is separate from the electrified vehicle during the grid power outage condition.
